(19) United States
(12) Patent Application Publication
(10) Pub. No.: US 2009/0023337 A1
(43) Pub. Date: Jan. 22, 2009

(54) Electrical connector

(75) Inventor: Jen-Jou Chang, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/218,753

(22) Filed: Jul. 16, 2008

(30) Foreign Application Priority Data
Jul. 16, 2007 (CN) 200720040749.4

(51) Int. Cl. H01R 13/648

(52) U.S. Cl. 439/607

(57) ABSTRACT

An electrical connector could mounted onto a PCB comprising an insulating housing with a plurality of contacts; a shielding surrounding the housing; an IC component congregating several ESD protecting members and electrical connecting the contacts. Said contacts consists of several signal contacts and at least a grounding contact; the electro-static of the signal contacts flow through the IC component to the grounding contact. Each contact comprises a soldering portion protruding out of a bottom side of the connector; at least one elastic arm extends from a top side of the connector corresponding to the soldering portions; and the IC component is sandwiched between the elastic arm and the soldering portions.

### BACKGROUND OF THE INVENTION

1. Field of the Invention

The present invention is generally related to an electrical connector, and especially to a connector which has an IC component congregating several ESD protecting members.

2. Description of Related Art

In general, a connector is used to connect two disconnected cables, or connect two disconnected circuits for electrical connection. Such connector is a well known art, and the universal series bus (USB) connector is one of the examples commonly used in such as computer hardware, personal digital assistant (PDA), mobile phone, etc.

An electrical connector of the related art, could mounted onto a PCB, comprises an insulator with a plurality of contacts, and a shielding housing surrounding the insulator. The contacts comprises several signal contacts and at least a grounding contacts. Wherein said insulator comprises an engaging portion with a plurality of grooves on a top surface; each contact, receiving in the corresponding groove, has a contacting portion protruding out of the groove for electrical connecting with another connector and a soldering end extending from a bottom end of the housing; and the shielding housing comprises several grounding ends for soldering onto the PCB. In use, the soldering ends and the grounding ends are soldered to the corresponding conduction area of the PCB so as to fix the connector onto the PCB firmly and connect with the circuit of PCB. A plurality of electro-static discharge (ESD) protecting members are pre-installed on the PCB, and each one end connects with a corresponding signal contact, and the other end connects with the grounding contact or the grounding end of the shielding housing. Therefore, the electro-static in the signal contacts flow through the protecting members to the ground, and achieve electro-static discharge protecting effect.

One problem of this type connector is that the ESC protecting members pre-install onto the PCB and separate from the connector, so occupy much area of the PCB, and turn against the miniaturization development trend of electronic device.

Hence, an improved card connector is highly desired to overcome the aforementioned disadvantages of the prior art.

### SUMMARY OF THE INVENTION

Accordingly, an object of the present invention is to provide a connector which is in accordance with the miniaturization development trend of electronic device.

To achieve the above object, an electrical connector could mounted onto a PCB comprising an insulating housing with a plurality of contacts; a shielding surrounding the housing; an IC component congregating several ESD protecting members and electrical connecting the contacts. Said contacts consists of several signal contacts and at least a grounding contact; the electro-static of the signal contacts flow through the IC component to the grounding contact. Each contact comprises a soldering portion protruding out of a bottom side of the connector; at least one elastic arm extends from a top side of the connector corresponding to the soldering portions; and the IC component is sandwiched between the elastic arm and the soldering portions.

Other objects, advantages and novel features of the present invention will be drawn from the following detailed description of a preferred embodiment of the present invention with attached drawings.

### BRIEF DESCRIPTION OF THE DRAWINGS

FIG. 1 is an assembled, perspective view of a connector in accordance with the present invention;

FIG. 2 is an enlarged section view of the connector of FIG. 1;

FIG. 3 is an exploded, perspective view of the connector of FIG. 1;

FIG. 4 is another exploded, perspective view of the connector of FIG. 1;

FIG. 5 is another angle of view of the connector of FIG. 3; and

FIG. 6 is a perspective view of the connector of the FIG. 1 without the IC component.

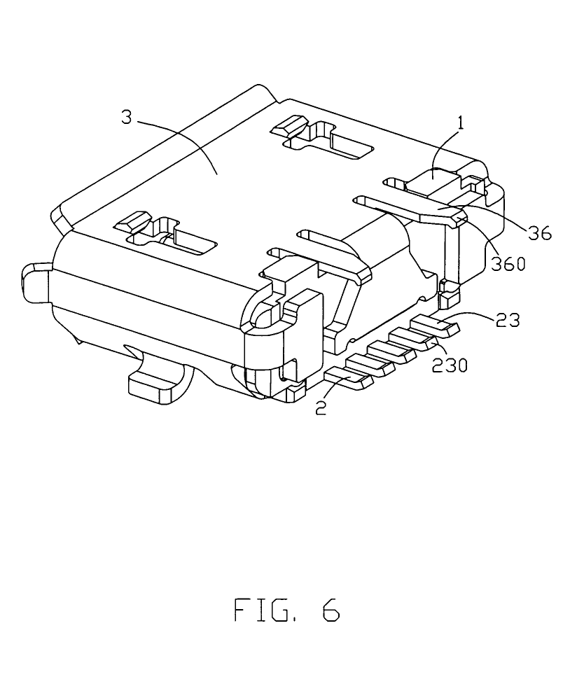

### DETAILED DESCRIPTION OF THE INVENTION

Reference will now be made in detail to the preferred embodiment of the present invention.

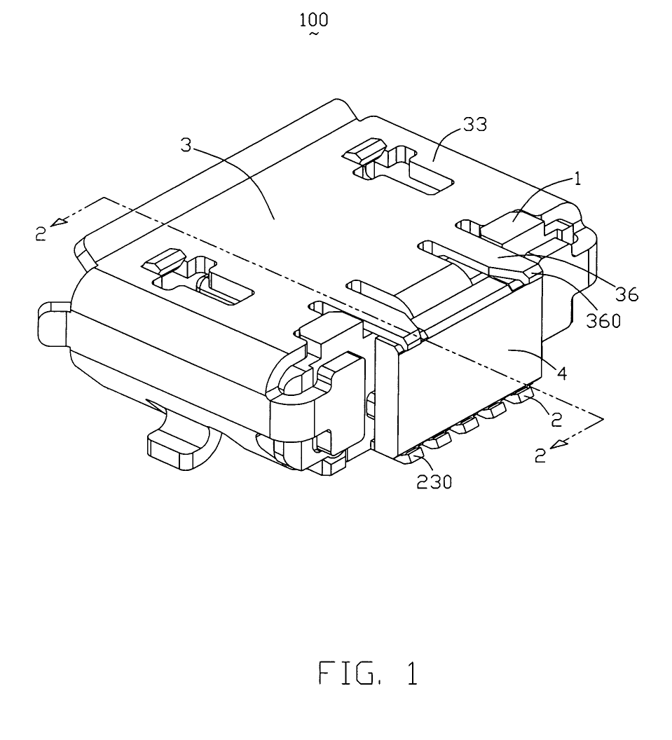

Referring to FIGS. 1-3, the connector 100 in accordance with the present invention comprises an insulating housing 1 with a plurality of contacts 2, a shielding surrounding the housing 1, and an integrated circuit (IC) component 4 connected with an end of the shielding.

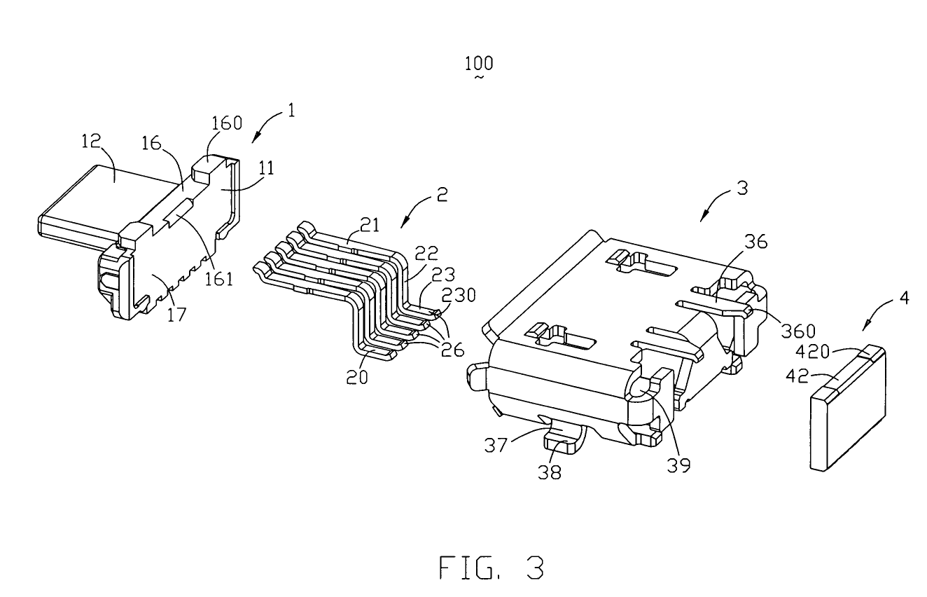

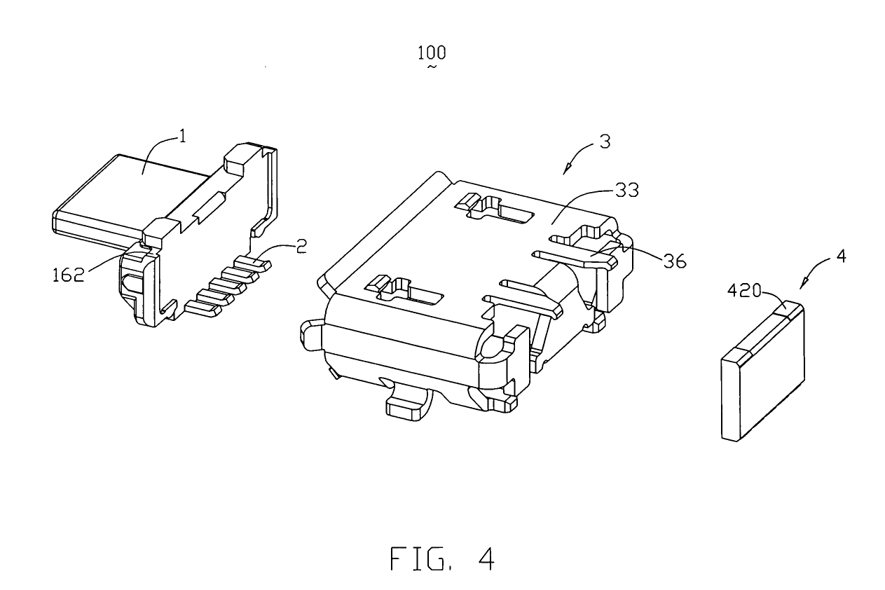

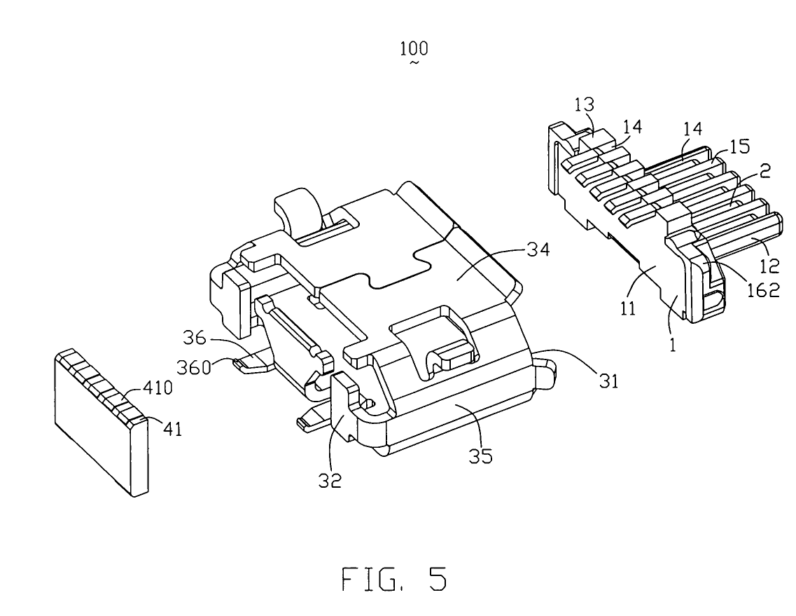

Referring to FIGS. 3-5, the housing 1 comprise a base portion 11 and a tongue 12 extending forward from the base portion 11. A plurality of receiving slots 14 penetrates through a lower surface 13 of the base portion 11 and a bottom 15 of the tongue 14 for receiving contacts 2. A pair of tabs 160 protrudes upward form two side of the top surface 16. A leading portion 161 is formed at a cross of the top surface 16 and a rear portion 17 and between the two tabs 160. Two pair of block 162 are formed on both two ends of the top surface 16 and the lower surface 13.

Referring to FIG. 3, said contacts 2 comprise several signal contact 26 and at least a grounding contact 20. Each contact 2 receiving in the corresponding receiving slot 14 of the housing 1, comprises a contacting portion 21 accepted in the tongue 12, a soldering portion 23 protruding backward from the bottom of the rear portion 17 for soldering to a printed circuit board (not shown), and a connecting portion 22 connecting the soldering portion 23 and the contacting portion 21 and secured in the base portion 11. The soldering portion 23 is coplanar with the lower surface 13, and has a wrapping portion 230 at a free end thereof.

Referring to FIGS. 3-5, the shielding comprises a inserted mouth 31 through that the tongue 12 of the housing could be seen, and a mounting portion 32 opposite to the mouth 31. The shielding has an upper wall 33, a lower wall 34, and two side wall 35 connect the upper wall 33 and the lower wall 34. A tearing portion 37 tears from the lower wall 34 to a lower portion of the sidewall and bends outward, and a horizontal portion 38 is formed on a free end of the tearing portion 37 for fixing the connector to the PCB and achieving efficacy of grounding, and is coplanar with the soldering portion 23 of the contact 2. A bending portion extending downward from the center of the upper wall 33, and a pair of another bending portion extending vis-a-vis from the two side walls 35 consist of the mounting portion 32 together; and several small openings 39 are formed on the mounting portion 32 for fastening the housing firmly onto the shielding. A pair of elastic arms 36 extends backward from the upper surface 36 and is spaced from the soldering portion 23 of the contact 2 in height, and a bending portion 360 bends toward the soldering portion 23 at a free end of the elastic arm 36.

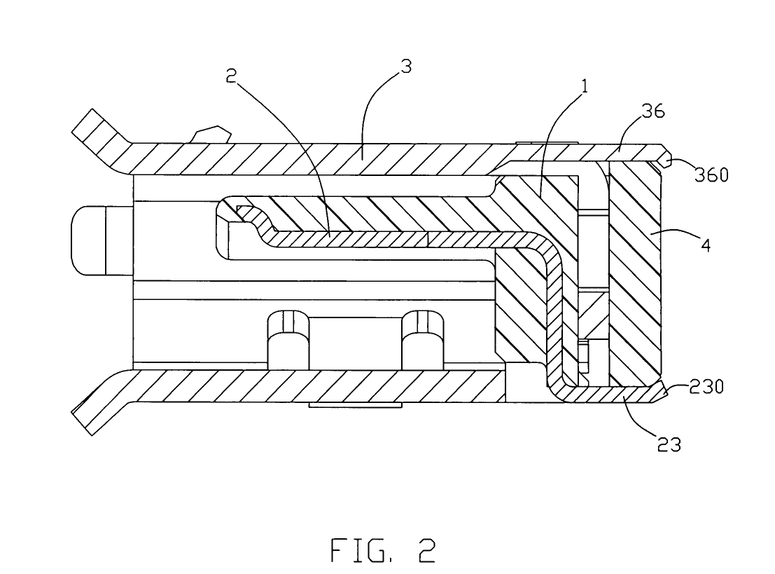

Referring to FIG. 2-5, the IC component is compressed, and congregates several ESD protecting members in the bowels. The IC component 4 is sandwiched between the soldering portion 23 and the elastic arm 36. IC component 4 comprises a plurality of conductive areas 410 electrical connecting with the corresponding contacts 2 on a bottom surface 41, and a pair of soldering areas 420 corresponding to the elastic arm 36 at a top surface 42. The surfaces of the elastic arms 36 and the soldering portion 230 engaging with the IC component 4 are pretreated to achieve the requirement of solderability, and some tin is add on both the conductive areas 410 and the soldering areas 420. Both the bending portion 360 and the soldering portion 230 could prevent the IC component 4 sliding out of the connector 100 on its way through transport before mounted onto the PCB.

The connector 100 in accordance with the present invention is used to be mounted onto the PCB without ESD protecting members. In the process of the connector 100 being mounted onto the PCB, the soldering portions 23 of the contacts 2 and the horizontal portions 38 of the shielding 3 are soldered onto corresponding conducting areas of the PCB by surface mount technology, and the tin on both the conductive areas 410 and the soldering areas 420 of the IC component 4 melts by the heat flow in above process, therefore, the conductive 410 is soldered on the soldering portions 23, the soldering area 420 is soldered on the conductive area 410 simultaneously.

The present electrical connector 100 takes advantage of the IC component 4 congregating several ESD protecting members sandwiched between the soldering portions 23 of the contacts 2 and the elastic arms 36 of shielding 3, and compares to the related art, could shorten the path of electrostatic, and further decrease the area of the PCB so as to be in accordance with the miniaturization development trend of electronic device.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An electrical connector could mounted onto a PCB comprising:
an insulating housing with a plurality of contacts;
a shielding surrounding the housing;
an IC component congregating several ESD protecting members and electrical connecting the contacts;
said contacts consisting of several signal contacts and at least a grounding contact; the electrostatic of the signal contacts flow through the IC component to the grounding contact; and
each contact comprising a soldering portion protruding out of a bottom side of the connector; at least one elastic arm extending from a top side of the connector corresponding to the soldering portions; and the IC component sandwiched between the elastic arm and the soldering portions.

2. The electrical connector as described in claim 1, wherein a bending portion extending downward from a free end of the elastic arm toward the soldering portion, and a wrapping portion extending upward from a free end of the soldering portion toward the elastic arm.

3. The electrical connector as described in claim 2, wherein the IC component comprises a plurality of conductive areas corresponding to the soldering portions of the contacts.

4. The electrical connector as described in claim 3, wherein the connector has two elastic arms engaging with two opposite edges of the IC component.

5. The electrical connector as described in claim 4, wherein the shielding has an upper wall, a lower wall, and two side wall connect the upper wall and the lower wall; a tearing portion tears from the lower wall to a lower portion of the sidewall and bends outward, and a horizontal portion is formed on a free end of the tearing portion, and is coplanar with the soldering portion of the contact.

6. The electrical connector as described in claim 5, wherein the elastic arm extends from the upper wall of the shielding.

7. The electrical connector as described in claim 6, wherein the IC component defines soldering areas corresponding the elastic arms; both the surfaces of the elastic arms and the soldering portion engaging with the IC component are pretreated to achieve the requirement of solderability, and some tin is add on both the conductive areas and the soldering areas.

8. An electrical connector, comprising:
a metallic shell configured by walls and defining a receiving space therebetween, the shell having a front opening and a rear wall with a rear duct;
a plurality of contacts insert received in the receiving space, and including contact engaging portions accessible from the front opening, and tail portions extending out of the shell through the rear duct; and
an electrical module retained to the rear wall and electrically connected to the tails portion of the contacts, respectively.

9. The electrical connector as described in claim 8, wherein at least an elastic arm extending from a top wall of the shielding and protruding out of the rear wall, and engaging with the module.

10. The electrical connector as described in claim 9, wherein a bending portion extending downward from a free end of the elastic arm toward the tail portion, and a wrapping portion extending upward from a free end of the tail portion toward the elastic arm.

11. The electrical connector as described in claim 10, wherein the module comprises a plurality of conductive areas corresponding to the tail portions of the contacts.

12. The electrical connector as described in claim 11, wherein the module defines soldering area corresponding the elastic arm; both the surfaces of the elastic arm and the soldering portion engaging with the IC component are pretreated to achieve the requirement of solderability, and some tin is add on both the conductive areas and the soldering areas.

13. An electrical connector assembly comprising:
a printed circuit board;
an insulative housing;
a plurality of contacts disposed in the housing, each of said contacts defining a front contacting section and a rear horizontally extending tail section, said tail section defining opposite upper and bottom surfaces under a condition that the surface of said tail section is soldered to said printed circuit board;
a metallic shield covering said housing and defining a grounding leg engaged with the printed circuit board; and
a noise-filtering component defining an upper end engaged with a rear region of the shield, and a lower end engaged with the upper surface of the tail section.

14. The electrical connector as claimed in claim 13, wherein the rear region of the shield defines a downward flange, and the tail section forms an upward flange to cooperate with said downward flange to abut against a rear face of the noise-filtering component for preventing said noise-filtering component from being rearwardly withdrawn from the connector.

15. The electrical connector as claimed in claim 13, wherein said noise-filtering component is exposed to an exterior behind the housing.

16. The electrical connector as claimed in claim 13, wherein the shield defines a top wall with a downward flange on the rear region, a rear wall extending from a top wall and covering a rear face of the housing under a condition that the noise-filtering component forwardly abuts against the rear wall and rearwardly abuts against said downward flange.

17. The electrical connector as claimed in claim 13, wherein said noise-filtering component is located at an outermost position of a rear portion of the connector.

18. The electrical connector as claimed in claim 13, wherein the rear region of said shield defines a flange abutting against a rear face of the noise-filtering component so as to prevent said noise-filtering component from being rearwardly withdrawn from the connector.
